(19) United States
(12) Patent Application Publication
(10) Pub. No.: US 2007/0187863 A1
(43) Pub. Date: Aug. 16, 2007

(54) Ultra-wide, anti-slippery rubber sheet and molding machine and method of fabricating the same

(75) Inventor: Chi Chin Lin, Nantou (TW)

Correspondence Address: Chun-Ming Shih, 4331 Stevens Battle Lane, Fairfax, VA, 22033, US

(73) Assignee: Hsin Yung Chien Co., Ltd.

(21) Appl. No.: 11/354,018

(22) Filed: Feb. 15, 2006

(51) Int. Cl. B29C 47/00

(52) U.S. Cl. 264/211.2; 425/461; 425/377

(57) ABSTRACT

An ultra-wide, anti-slippery rubber sheet used for vehicle flooring, and a method of fabricating and shaping the same. A mixed material made of a rubber raw material is extruded and roll pressed with a predetermined width and thickness. The extruded and shaped material is then mold pressed by a pattern mold and vulcanized. A molding machine having a screw extruder, a rolling pressing machine, and vulcanizer is used for manufacturing the ultra-side rubber sheet.

### BACKGROUND OF THE INVENTION

1. Field of Invention

The present invention relates in general to an ultra-wide, anti-slippery rubber sheet and a molding machine and a method of fabricating the rubber sheet.

2. Related Art

In most of the large-size vehicles such as the large-size bus, a plastic layer or a rubber flooring is typically installed for anti-slippery and safety concern. Referring to FIGS. 10 and 11, due to the technical problem for manufacturing rubber sheet, the width of the rubber sheet is typically limited. Three rubber sheets 81, 82 and 83 are thus required to cover the floor surface of the bus. The rubber sheets 81, 82 and 83 are then permanently installed on the floor using battens 84 and nails 85. The installation is very labor costly and time consuming because the rubber sheets 81, 82 and 83 have to be placed one by one on the floor, precise alignment between each other is required, and the battens 84 and nails 85 have to be manually applied.

### SUMMARY OF THE INVENTION

The present invention is to provide an integrally formed ultra-wide, anti-slippery rubber sheet for vehicle flooring, and a molding machine and a method for fabricating the rubber sheet to simplify the installation and reduce the cost of the installation.

Accordingly, the method for of manufacturing an ultra-wide, anti-slippery rubber sheet for vehicle flooring comprises extruding a rubber material into a flat rubber sheet, roll pressing and molding the flat rubber sheet with a predetermined thickness and width, and applying the flat rubber sheet to a roller that comprising a patterning mold to perform continuous mold pressing and vulcanization, so as to form the rubber sheet with a predetermined pattern.

The molding machine for manufacturing an ultra-wide, anti-slippery rubber sheet used for vehicle flooring, comprises a screw extruder, a roller head device and a vulcanizer. The screw extruder includes an extrusion head, a cylinder driven by a screw installed therein for mixing and conveying a rubber material, and a first driving device for driving the screw. The roller head device includes at least a first roller, a second roller, and a second driving device for driving the first and second rollers, so as to roll and press the rubber material extruded by the screw extruder with a predetermined thickness and width. The vulcanizer includes a heated roller, a driven roller, a driving roller, a stretching roller, a steel belt and a third driving device. The heated roller further includes a heating source installed therein and a patterning mold mounted to a surface thereof. The driven roller is located at a first side of the heated roller and close thereto, the driven roller is driven by the heated roller. The driving roller is located at the first side of the heated roller and close thereto. The stretching roller is located at a second side of the heated roller and distal thereto. The steel belt extends along and circulating between the heated, driven, driving and stretching rollers and is strained by rotation of the stretching roller. The third driving device is for generating an actuation force, so as to drive the driving roller to actuate rotations of the heated, driven and stretching rollers. The rotation of the heated and driven rollers drives the steel belt to convey the rubber material to the heated roller from between the heated and driven rollers, so as to perform continuous mold pressing and vulcanization on the rubber material on the heated roller to form the rubber sheet with a predetermined surface pattern.

The ultra-wide, anti-slippery rubber sheet suitable for use in vehicle flooring, includes a first side board, a second side board, and a central board integrally formed, wherein the rubber sheet has a width and a length no smaller than 1.8 m and 9 m, respectively.

### BRIEF DESCRIPTION OF THE DRAWINGS

The present invention will become more fully understood from the detailed description given hereinbelow illustration only, and thus are not limitative of the present invention, and wherein:

FIG. 1 illustrates a top view of an ultra-wide, anti-slippery rubber sheet used for vehicle flooring;

FIG. 2 illustrates an exemplary cross section of the rubber sheet along line A-A in FIG. 1;

FIG. 3 shows another exemplary cross section of the rubber sheet as shown in FIG. 1;

FIG. 4 illustrates a front view of a screw-type extruder and a roller head device of a molding device used to manufacture the ultra-wide, anti-slippery rubber sheet;

FIG. 5 illustrates a top view of the screw extruder as shown in FIG. 4;

FIG. 6 shows a front view of a vulcanizer in the molding machine;

FIG. 7 shows a cross sectional view of the vulcanizer along line C-C as shown in FIG. 6;

FIG. 8 shows a cross-sectional view of a heated roller in the vulcanizer of the molding machine, a heat supply device and an oil supply device;

FIG. 9 shows a front view of a molded ultra-wide, anti-slippery rubber sheet for vehicle flooring;

FIG. 10 shows the application of an ultra-wide ant-slippery rubber sheet to a vehicle; and

FIG. 11 shows a cross sectional view along line X-X of FIG. 10.

### DETAILED DESCRIPTION OF THE INVENTION

The method of fabricating an ultra-wide, anti-slippery rubber sheet as provided includes the following steps. A rubber raw material is extruded into a flat rubber sheet. The flat rubber sheet is roll pressed with a predetermined thickness and width. The roll pressed rubber sheet is then placed on a roller with a pattern formed thereon for continuous mold press and vulcanization. Thereby, a vulcanized rubber sheet contains the desired pattern can be obtained.

There are two options for mold pressing and vulcanizing the roll pressed rubber sheet. Firstly, the rubber sheet can be mold pressed and vulcanized into the end product with the desired width and applied as the anti-slippery flooring in a vehicle. The second option includes performing mold pressing and vulcanization on two rubber sheets with smaller dimensions arranged in parallel. By controlling the vulcanization temperature between about 130° C. and about 200° C., preferably about 160° C. and about 180° C., the rubber sheets are merged as an integral sheet of rubber material with the desired width and dimension.

In one embodiment, the vulcanization pressure is about 1 to 10 kgf/cm², preferably about 2-5 kgf/cm². The vulcanization pressure is defined as the surface pressure applied to the rubber sheet.

In one embodiment, the production speed of the rubber sheet is about 0.1-4 M/min, preferably 0.2-2 M/min. The roller as mentioned above includes a rotocure press, for example.

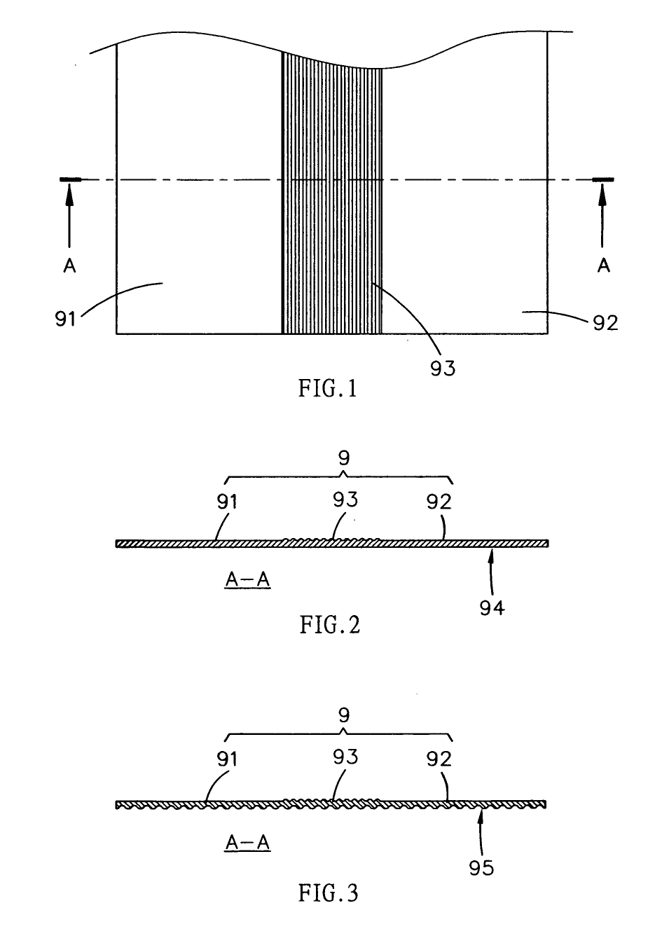

The ultra-wide, anti-slippery rubber sheet 9 manufactured by the above process is illustrated in FIGS. 1 to 3. The ultra-wide, anti-slippery rubber sheet 9 includes a first side board 91, a second side board 92, and at least a central board 93 interposed between the first and second side boards 91 and 92. For example, the minimum width and length of the rubber sheet 9 is about 1.8 m and 9 m.

The rear side of the rubber sheet 9 can be configured into a flat surface 94 or a surface with a uniform pattern 95 as shown in FIGS. 2 and 3, respectively.

The molding machine for manufacturing the rubber sheet 9 includes a screw extruder 4 for extruding a rubber material, a roller head device 3 for rolling and pressing the extruded the rubber material with a predetermined thickness and width, and a vulcanizer 20.

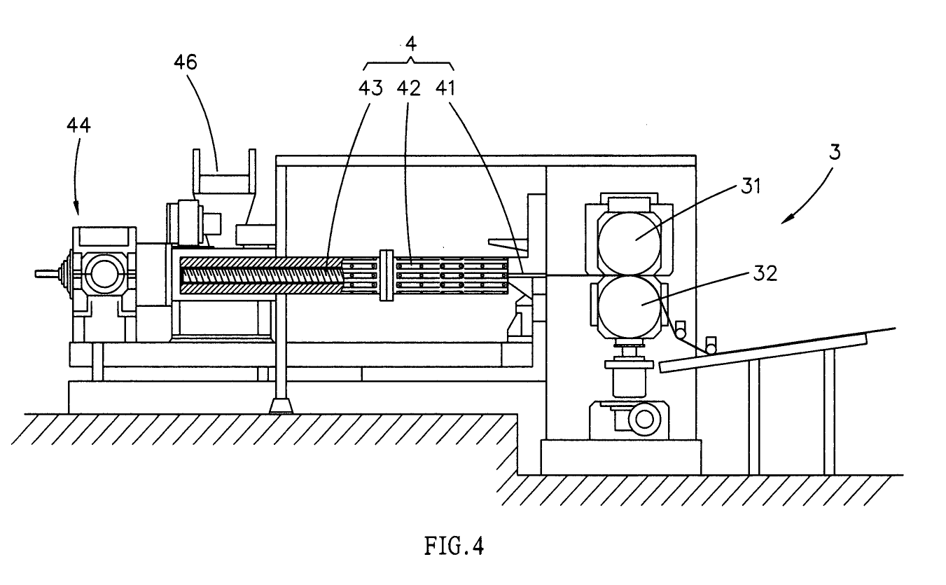

The screw extruder 4 includes an extrusion head 41, a cylinder 42 containing mixed and conveyed rubber material, a screw 43 in the cylinder 42, and a first driving device 44 for driving the screw 43 (as shown in FIGS. 4, 5 and 9).

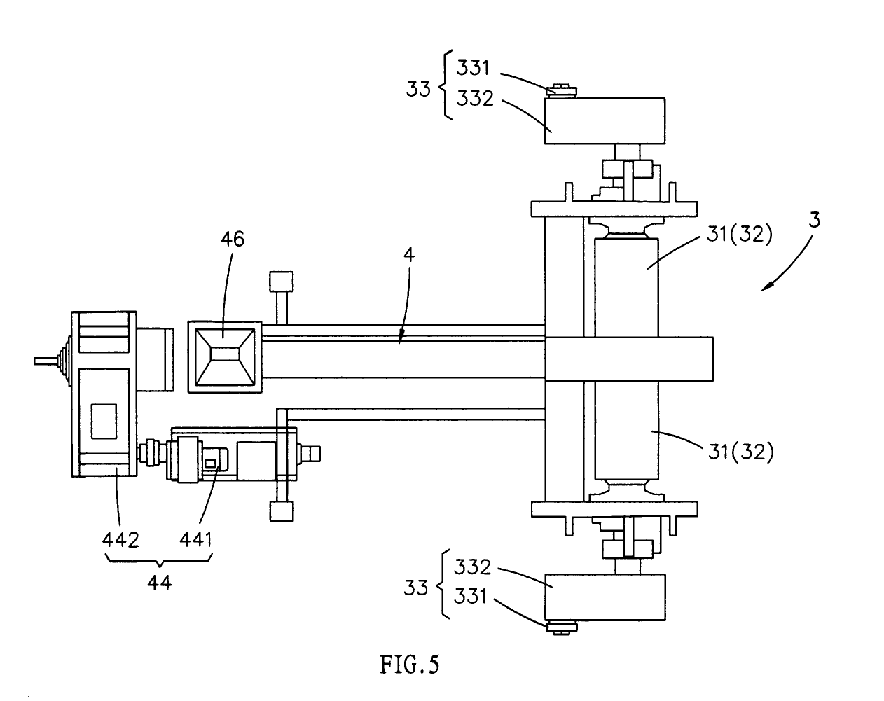

The roller head device 3 includes at least a first roller 31, a second roller 32, a second driving device 33 for driving the first and second rollers 31 and 32. As discussed above, the roller head device 3 is operative to roll and press the extruded rubber material with predetermined thickness and width (as shown in FIGS. 4 and 5).

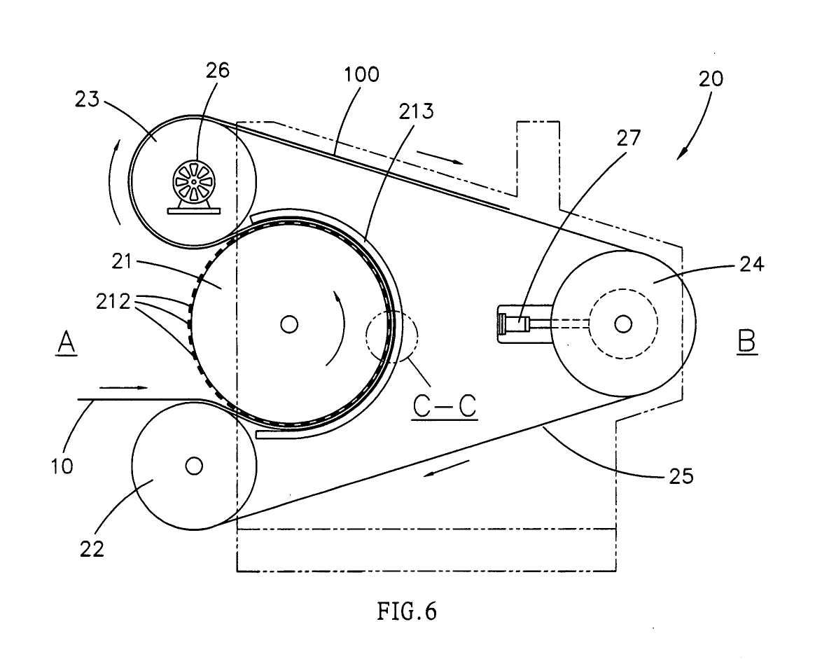

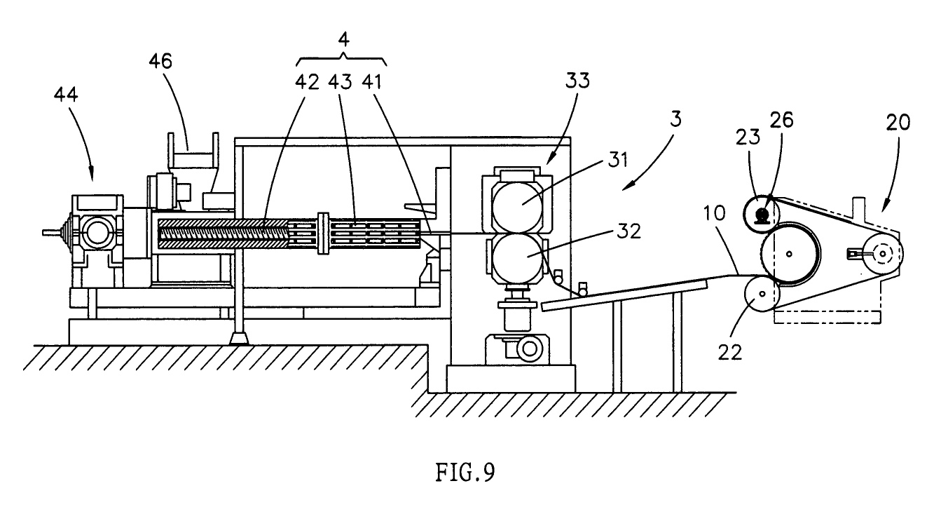

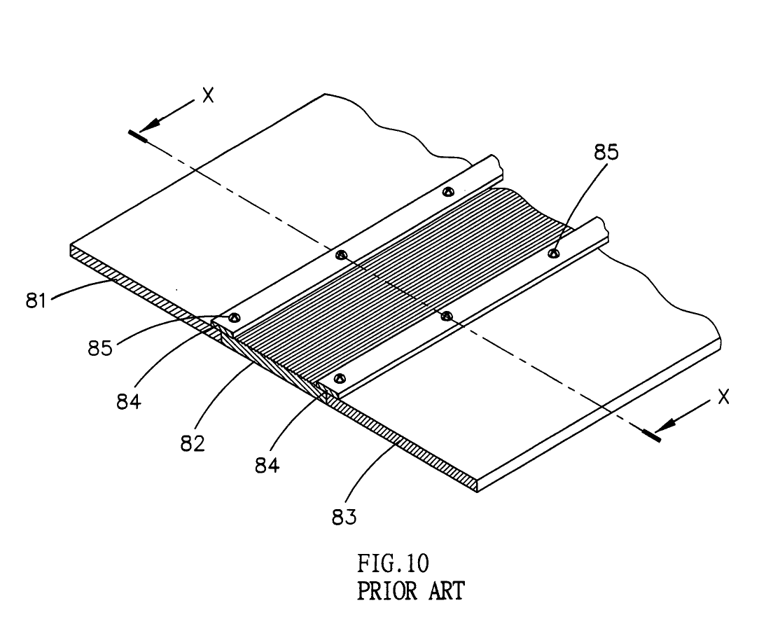

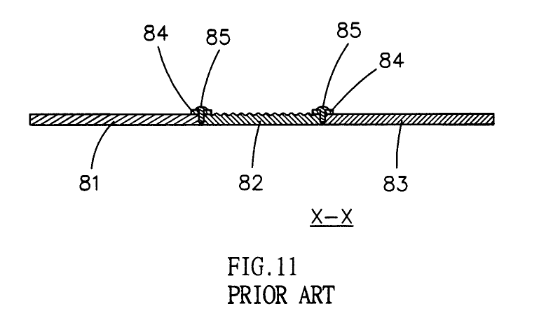

The vulcanizer 20 includes a heated roller 21, a driven roller 22, an driving roller 23, a stretching roller 24, a steel belt 25 and a third driving device 26 (Referring to FIGS. 6 and 9).

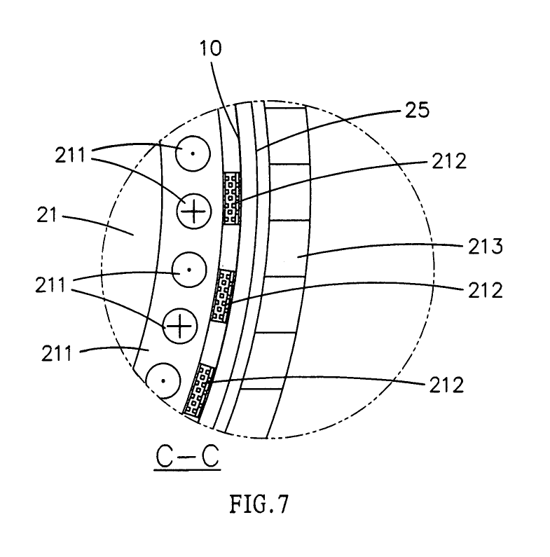

As shown in FIG. 7, the heated roller 21 of the vulcanizer 20 includes a heat source 211 and a mold 212 on the surface of the heated roller 212.

Referring to FIG. 6, the driven roller 22 and the driving roller 23 are located at a first side A of the heated roller 21 and close to the heated roller 21, while the stretching roller 24 is located at the opposing side B of the heated roller 21 and distal thereto.

Preferably, the steel belt 25 links and extends along the stretching roller 24, the driving roller 23, the heated roller 21 and the driven roller 22.

When the third driving device 26 exerts a tension to rotate the driving roller 23, the steel belt 25 delivers the force to rotate the heated roller 21, the driven roller 22 and the stretching roller 24, such that the rubber material 10 that has not been vulcanized is input between the driven and heated rollers 22 and 21 and carried to the heated roller 21 by the steel belt 25 to be mold pressed and vulcanized.

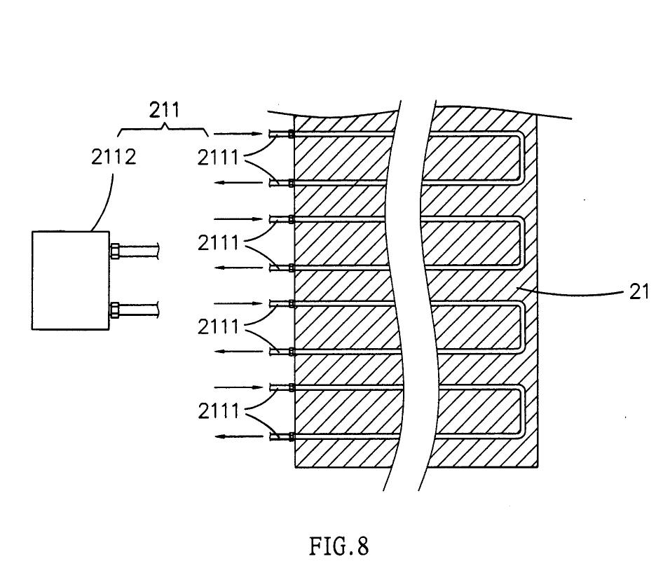

As shown in FIGS. 7 and 8, the heat source 211 is a device of heating oil medium which includes a plurality of oil pipes 2111 located within the heated roller 21 and close to the surface thereof and a oil supplying device 2112 to supply the heating oil medium to the heated roller 21.

As shown in FIG. 7, a heating element 213 may also be installed near the surface of the steel belt 25 close to the heated roller 21. The heating element 213 includes a radiator, for example.

As shown in FIG. 6, a supporting device 27 such as an oil pressure cylinder is used to push the stretching roller 24 away from the heated roller 21, so as to provide sufficient strain to the steel belt 25 and allow the rubber material 10 to be processed closely attached to the heated roller 21 and the mold 212.

The first driving device 44 includes a motor 441 and a gear box 442, while the second driving device 33 includes another motor 331 and gear box 332, for example.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of manufacturing an ultra-wide, anti-slippery rubber sheet for vehicle flooring, comprising:
extruding a rubber material into a flat rubber sheet;
roll pressing and molding the flat rubber sheet with a predetermined thickness and width; and
applying the flat rubber sheet to a roller that comprising a patterning mold to perform continuous mold pressing and vulcanization, so as to form the rubber sheet with a predetermined pattern.

2. The method of claim 1, wherein the roller includes a rotocure press.

3. The method of claim 1, further comprising a material mixture step to make the rubber material.

4. The method of claim 1, wherein the vulcanization is controlled at a temperature of about 130-200° C.

5. The method of claim 4, wherein the temperature is about 160-180° C.

6. The method of claim 1, wherein the vulcanization is controlled at a pressure of about 1-10 kgf/cm².

7. The method of claim 6, wherein the pressure is about 2-5 kgf/cm².

8. The method of claim 1, further comprising a step of fabricating the rubber sheet at a speed of about 0.1-4 M/min.

9. The method of claim 8, wherein the speed is about 0.2-2 M/min.

10. A molding machine for manufacturing an ultra-wide, anti-slippery rubber sheet used for vehicle flooring, comprising:
a screw extruder, having an extrusion head, a cylinder driven by a screw installed therein for mixing and conveying a rubber material, and a first driving device for driving the screw;
a roller head device having at least a first roller, a second roller, and a second driving device for driving the first and second rollers, so as to roll and press the rubber material extruded by the screw extruder with a predetermined thickness and width;
a vulcanizer, including:
a heated roller, further comprising a heating source installed therein and a patterning mold mounted to a surface thereof;
a driven roller located at a first side of the heated roller and close thereto, the driven roller being driven by the heated roller;
a driving roller located at the first side of the heated roller and close thereto;
a stretching roller located at a second side of the heated roller and distal thereto;
a steel belt extending along and circulating between the heated, driven, driving and stretching rollers and strained by rotation of the stretching roller; and
a third driving device for generating a tension, so as to drive the driving roller to actuate rotations of the heated, driven and stretching rollers, wherein rotation of the heated and driven rollers drives the steel belt to convey the rubber material to the heated roller from between the heated and driven rollers, so as to perform continuous mold pressing and vulcanization on the rubber material on the heated roller to form the rubber sheet with a predetermined surface pattern.

11. The molding machine of claim 10, wherein the heat source includes a plurality of oil pipes installed within and close to a surface of the heated roller and an oil supply device for supplying heating oil into the oil pipe.

12. The molding machine of claim 10, further comprising a heating element located external to the heated roller and close to the steel belt.

13. The molding machine of claim 10, further comprising a pushing device to push the stretching roller away from the heated roller.

14. The molding machine of claim 13, wherein the pushing device includes an oil pressure cylinder.

15. The molding machine of claim 10, further comprising a material supply located at a front side of the screw extruder.

16. The molding machine of claim 10, wherein the first driving device includes a motor and a gear box.

17. The molding machine of claim 10, wherein the second driving device includes a motor and a gear box.

18. An ultra-wide, anti-slippery rubber sheet suitable for use in vehicle flooring, includes a first side board, a second side board, and a central board integrally formed, wherein the rubber sheet has a width and a length no smaller than 1.8 m and 9 m, respectively.

19. The rubber sheet of claim 18, wherein a rear surface of the rubber sheet is configured into a planar surface or with a uniform pattern.

20. The rubber sheet of claim 18, wherein the central board is configured with an anti-slippery pattern.
